(19) United States
(12) Patent Application Publication
(10) Pub. No.: US 2025/0196296 A1
(43) Pub. Date: Jun. 19, 2025

(54) ASSEMBLY DEVICE OF SCAN MIRROR

(71) Applicant: Samsung Display Co., LTD., Yongin-si (KR)

(72) Inventors: EUN SU JUN, Yongin-si (KR); HYOUNG-JOO KIM, Yongin-si (KR); ILYOUNG JEONG, Yongin-si (KR); KUHYUN KANG, Yongin-si (KR); HAK-MIN KIM, Yongin-si (KR)

(21) Appl. No.: 18/966,430

(22) Filed: Dec. 3, 2024

(30) Foreign Application Priority Data
Dec. 13, 2023 (KR) 10-2023-0181289

(51) Int. Cl. B25B 11/02; G02B 26/10

(52) U.S. Cl. CPC B25B 11/02; G02B 26/105

(57) ABSTRACT

An assembly device of a scan mirror is a device for assembling a scan mirror including an encoder, a first part disposed on the encoder and including a coil, a third part disposed on the first part and of a cylindrical shape having a reference diameter that serves as an assembly standard, a mount disposed on the third part, and a Galvo mirror coupled to the mount to receive rotational force of the coil. The assembly device of the scan mirror includes a first assembly jig including a first surface defined with a first groove into which the Galvo mirror is allowed be seated, a second assembly jig including a third surface defined with a second groove into which the third part is allowed be seated and an upper fixing guide disposed on the second assembly jig and fixing the third part together with the second assembly jig.

This application claims priority to Korean Patent Application No. 10-2023-0181289, filed on Dec. 13, 2023, and all the benefits accruing therefrom under 35 U.S.C. § 119, the content of which in its entirety is herein incorporated by reference.

### BACKGROUND

### 1. Field

Embodiments relate to an assembly device of a scan mirror. More specifically, embodiments relate to an assembly device of a scan mirror for replacing a damaged Galvo mirror.

### 2. Description of the Related Art

A display device is a device that displays images to provide visual information to users. The display device are used in variety of ways, from displays for small products such as mobile phones to displays for large products such as televisions.

A laser may be used in a manufacturing process of a display device. The laser may be high-density heat sources that may be used for marking on an object to be processed, cutting along patterns of the object to be processed, welding or heat treating the object to be processed. Laser processing has various desired characteristics of being non-contact, causing less wear and allowing fine processing.

### SUMMARY

In a manufacturing process of a display device using a laser, a scanner may adjust an radiation position of the laser beam. When an error occurs in a position of the scanner, a quality of the display device may deteriorate due to the position where a final pattern is formed deviates from a designed position.

Embodiments provide an assembly device of a scan mirror.

An assembly device of a scan mirror according to embodiments of the disclosure is a device for assembling a scan mirror including an encoder, a first part disposed on the encoder and including a coil, a third part disposed on the first part and of a cylindrical shape having a reference diameter which serves as an assembly standard, a mount disposed on the third part, and a Galvo mirror coupled to the mount to receive rotational force of the coil. In such embodiments, the assembly device of the scan mirror includes a first assembly jig including a first surface, where a first groove, into which the Galvo mirror is allowed to be seated, is defined on the first surface, a second assembly jig including a third surface defined with a second groove, into which the third part is allowed to be seated, is defined on the third surface, and an upper fixing guide disposed on the second assembly jig, where the upper fixing guide fixes the third part together with the second assembly jig.

In an embodiment, the assembly device of the scan mirror may further include a first base and a second base. In such an embodiment, the first base may be disposed under the first assembly jig and the second assembly jig and may fix the first assembly jig and the second assembly jig. In such an embodiment, the second base may include a fifth surface and a sixth surface, where the fifth surface may be in contact with the first assembly jig, and the sixth surface may be in contact with the first base.

In an embodiment, the first assembly jig may be detachably coupled to the second base.

In an embodiment, a rail groove may define on the fifth surface of the second base. In such an embodiment, the first assembly jig may further include a rail. In such an embodiment, the rail may be disposed on a second surface opposite the first surface, and the rail may be fitted into the rail groove and movable linearly along the rail groove.

In an embodiment, the assembly device of the scan mirror may further include a mount fixture disposed on the second base. In such an embodiment, the mount fixture may include a flat surface on which the mount is seated, where the mount fixture fixes the mount not to allow a rotation of the rotation of the mount.

In an embodiment, a shape of the first groove of the first assembly jig may correspond to a shape of the Galvo mirror.

In an embodiment, the assembly device of the scan mirror may further include a first hinge connecting the second assembly jig and the upper fixing guide. In such an embodiment, the first hinge may include a hinge axis. In such an embodiment, a first end of the upper fixing guide may rotate around the hinge axis.

In an embodiment, the assembly device of the scan mirror may further include a hinge, the hinge may include a pressing plate disposed at a second end opposite to the first end of the upper fixing guide, a rotating plate rotatably connected to the pressing plate, where a fastening hole may be defined through the rotating plate, and a stopper disposed on the second assembly jig and including a coupling protrusion to which the fastening hole is coupled.

In an embodiment, the upper fixing guide may be coupled to or decoupled from the second assembly jig by the hinge in a one-touch manner, the third part may seat in the second groove in a state in which the upper fixing guide and the hinge are decoupled, and the third part is fixed by the upper fixing guide and the second assembly jig in a state in which the upper fixing guide and the hinge may be coupled.

In an embodiment, the assembly device of the scan mirror may further include an encoder base positioned to be spaced apart from the second assembly jig, where a third groove, in which the encoder is allowed be seated, may be defined on the encoder.

An assembly device of a scan mirror according to embodiments of the disclosure is a device for assembling a scan mirror including an encoder, a first part disposed on the encoder and including a coil, a third part disposed on the first part and of a cylindrical shape having a reference diameter that serves as an assembly standard, a mount disposed on the third part, and a Galvo mirror coupled to the mount to receive rotational force of the coil, where the assembly device of the scan mirror includes a second assembly jig having a first inner diameter into which an outer diameter of the third part is allowed be inserted and fixed, a motor support bracket including a contact surface in contact with a bottom surface of the encoder, and a guide which protrudes from the contact surface to have a certain length and has a second inner diameter into which the outer diameter of the encoder maybe inserted and fixed; and a first base having a third inner diameter into which the first part is allowed be inserted and fixed. In such embodiments, the second assembly jig and the first base are coupled to each other, and the motor support bracket and the first base are coupled to each other to fix the encoder, the first part, and the third part.

In an embodiment, the assembly device of the scan mirror may further include a first assembly jig spaced apart from the first base and including a first surface, where a first groove, into which the Galvo mirror is allowed be seated, is defined on the first surface, a second base disposed under the first assembly jig and fixing the first assembly jig, and a third base disposed under the second base and fixing the second base.

In an embodiment, the first assembly jig may be detachably coupled to the second base.

In an embodiment, the second base may include a fifth surface and a sixth surface, a rail groove may be defined on the fifth surface, the sixth surface may contact the third base, the first assembly jig may include a rail, the rail may be disposed on a second surface opposite the first surface, and the rail may be fitted into the rail groove and movable linearly along the rail groove.

In an embodiment, a shape of the first groove of the first assembly jig may correspond to a shape of the Galvo mirror.

In an embodiment, the assembly device of the scan mirror may further include a manual jig positioned between the first assembly jig and the first base, where a height of an upper surface may be adjust by the manual jig.

In an embodiment, the assembly device of the scan mirror may further include a mount fixture disposed on the manual jig, the mount fixture may include a flat surface on which the mount is seated, where the mount fixture may fix the mount not to allow rotation of the mount.

In an embodiment, the second assembly jig and the first base may be coupled to each other with bolts, the motor support bracket and the first base may be coupled to each other with bolts.

In an embodiment, the assembly device of the scan mirror may further include an air supply part which protrudes from the first part, where an air hole is defined in the air supply part to supply air to an inside of the first part, the air supply part may have a square shape in a plan view, and the first base may protrude inwardly to contact two opposite sides of the square shape and may further include a second hinge which fixes the air supply part.

A assembly device of a scan mirror according to an embodiment of the disclosure may include a first assembly jig, a second assembly jig, and a upper fixing guide. The first assembly jig may include a first surface, and a first groove on which a Galvo mirror may be seated may be defined in the first surface. The second assembly jig may include a third surface. The second groove on which the third part of the scan mirror may be seated may be defined in the third surface. The upper fixing hinge may fix the third part together with the second assembly jig.

A assembly device of a scan mirror ice according to another embodiment of the disclosure includes a second assembly jig, a motor support bracket, and a first base. The second assembly jig may have a first inner diameter into which an outer diameter of the third part of the scan mirror may be inserted and fixed. The motor support bracket may include a contact surface and a second inner diameter. The contact surface may contact a bottom surface of the encoder of the scan mirror. The second inner diameter may protrude from the contact surface to have a certain length. The second inner diameter into which an outer diameter of the encoder may be inserted and fixed. The second assembly jig and the first base may be coupled together, and the motor support bracket and the first base may be coupled together, and the encoder, the first part, and the third part may be fixed.

A assembly device of a scan mirror may fix the motor of the scan mirror based on the third part and quickly and accurately assemble the Galvo mirror to the motor regardless of the angle.

### BRIEF DESCRIPTION OF THE DRAWINGS

FIG. 1 is a block diagram illustrating a laser processing device according to an embodiment of the disclosure.

FIG. 2 is a view illustrating a scanner included in the laser processing device of FIG. 1.

FIG. 3 is a view illustrating a scan mirror included in the scanner of FIG. 2.

FIG. 4 is a side view illustrating the mirror fixture of FIG. 3.

FIG. 5 is a cross-sectional view taken along line I-I′ of FIG. 4.

FIG. 6 is a perspective view illustrating the assembly device of the scan mirror according to an embodiment.

FIG. 7 is an exploded perspective view of the assembly device of the scan mirror of FIG. 6.

FIG. 8 is a view illustrating the first assembly jig included in the assembly device of the scan mirror of FIG. 6.

FIG. 9 is a view illustrating the Galvo mirror mounted on the first assembly jig of FIG. 8.

FIG. 10 is a view illustrating the second base included in the assembly device of the scan mirror of FIG. 6.

FIGS. 11, 12, 13, 14, and 15 are views illustrating a method of assembling the scan mirror using the assembly device of the scan mirror of FIG. 6.

FIGS. 16 and 17 are perspective views illustrating the assembly device of the scan mirror according to another embodiment.

FIG. 18 is an exploded perspective view of the assembly device of the scan mirror of FIG. 16.

FIG. 19 is a view illustrating a second assembly jig included in the assembly device of the scan mirror of FIG. 16.

FIGS. 20 and 21 are views illustrating the manual jig included in the assembly device of the scan mirror of FIG. 16.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments will be described in detail with reference to the accompanying drawings. The same reference numerals are used for the same components in the drawings, and any repetitive detailed descriptions of the same components will be omitted or simplified.

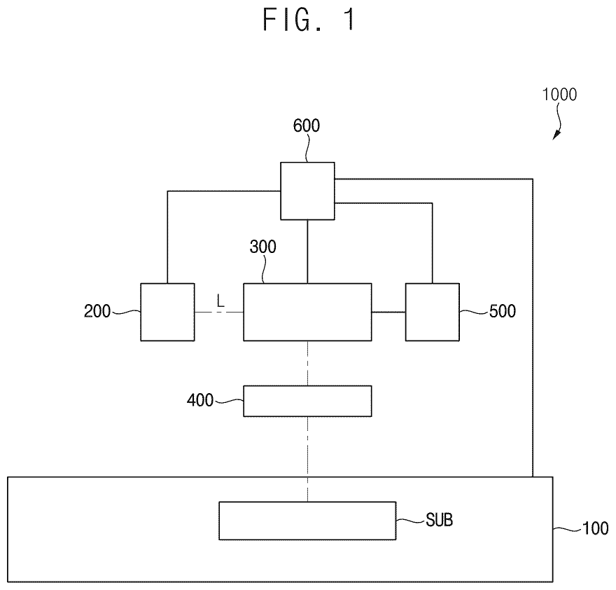

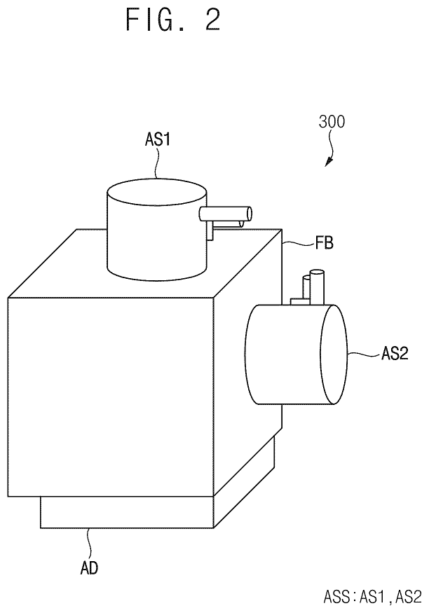

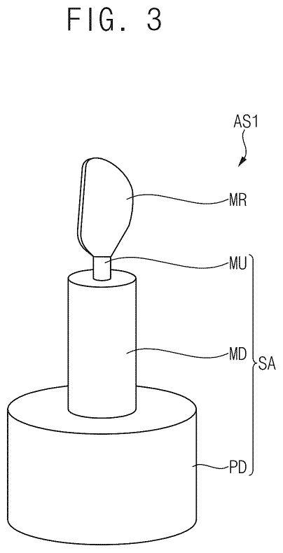

FIG. 1 is a block diagram illustrating a laser processing device according to an embodiment of the disclosure. FIG. 2 is a view illustrating a scanner included in the laser processing device of FIG. 1. FIG. 3 is a view illustrating a scan mirror included in the scanner of FIG. 2.

Referring to FIGS. 1, 2, and 3, a laser processing device 1000 according to an embodiment of the disclosure may include a laser source 200, a scanner 300, a lens unit 400, an aligner 500, and a control unit 600. The laser processing device 1000 may be a device that processes (e.g., performs a cutting process) an object to be processed SUB on a stage 100.

In an embodiment, for example, the laser processing device 1000 may be a laser cutting device. For example, the laser cutting device may cut materials of various thicknesses. For example, the laser cutting device may cut a mother glass. For example, the mother glass may have a multi-layer structure in which various layers are formed in the glass. The laser cutting device may cut the mother glass and separate the mother glass into a dummy and a panel. As the laser cutting device cuts the mother glass in a non-contact manner, deformation of the material, damage or the like may be effectively prevented.

The laser source 200 may generate a laser beam L. The laser beam L may be radiated from the laser source 200 toward the object to be processed SUB on the stage 100.

In an embodiment, for example, the laser source 200 may continuously emit the laser beam L. In another embodiment, for example, the laser source 200 may discontinuously emit the laser beam L.

In an embodiment, for example, the laser source 200 may emit a single beam. In another embodiment, for example, the laser source 200 may emit multi-beams.

In an embodiment, for example, a path conversion unit (not shown) may be disposed between the laser source 200 and the scanner 300. The path conversion unit may correct a path of the laser beam L emitted from the laser source 200 so that the laser beam Lis directed toward the scanner 300. In an embodiment, for example, the path conversion unit may be omitted. In such an embodiment, where the path conversion unit is omitted, the laser beam L emitted from the laser source 200 may travel straight and be directly incident on the scanner 300.

The scanner 300 may be disposed in the incident path of the laser beam L. In an embodiment, for example, as described above, the laser beam L emitted from the laser source 200 may be directly incident on the scanner 300. In another embodiment, for example, the laser beam L emitted from the laser source 200 may be incident on the scanner 300 through the path conversion unit.

The scanner 300 may deflect the laser beam L. In an embodiment, for example, the scanner 300 may deflect the laser beam L in X and Y directions on a plane. In other words, the scanner 300 may deflect the laser beam L to various positions by forming a two-dimensional area (i.e., scan field).

In an embodiment, as shown of FIG. 2, the scanner 300 may include at least one assembly ASS and a housing FB. In an embodiment, for example, the scanner 300 may be a two-axis optical scanner. In an embodiment, for example, the two-axis optical scanner may include a first assembly AS1, a second assembly AS2, and the housing FB. However, the disclosure is not limited thereto. In an embodiment, the scanner 300 may further include various components, or some of the components may be omitted. In an embodiment, for example, the scanner 300 may be a single-axis scanner, a three-axis scanner, or the like.

In an embodiment, the housing FB may fix the first assembly AS1 and the second assembly AS2. In such an embodiment, the housing FB may further include a lens adapter AD. The lens adapter AD may couple the housing FB and the lens unit 400.

In an embodiment, as shown of FIG. 3, each of the first assembly AS1 and the second assembly AS2 may include a Galvo mirror MR and a mirror fixture SA.

As the Galvo mirror MR rotates, the scanner 300 may deflect the laser beam L. In an embodiment, for example, the Galvo mirror MR may include a first mirror and a second mirror. The first mirror may be included in the first assembly AS1. The first mirror may deflect the laser beam L in a first direction. The second mirror may be included in the second assembly AS2. The second mirror may deflect the laser beam L in a second direction.

Here, the first direction and the second direction may cross each other. For example, the first direction may be the X direction, and the second direction may be the Y direction.

In an embodiment, for example, each of the first assembly AS1 and the second assembly AS2 may include a substantially same configuration as each other except for the Galvo mirror MR. Therefore, the following description will focus on the first assembly AS1.

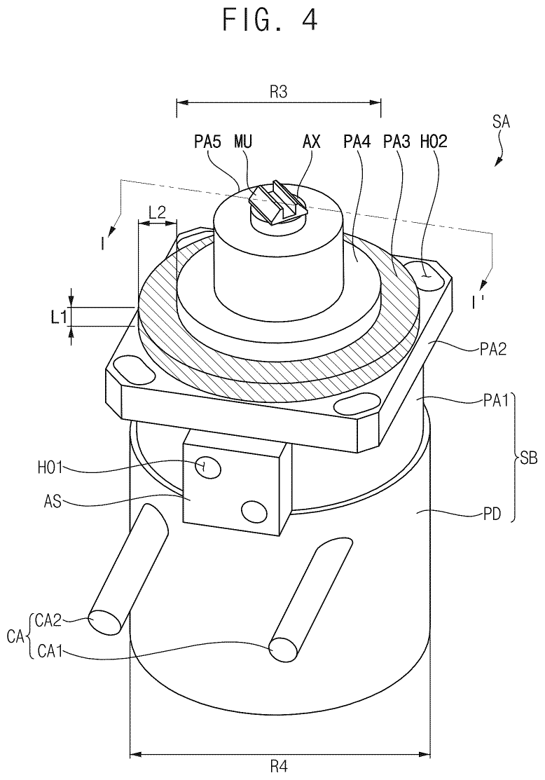

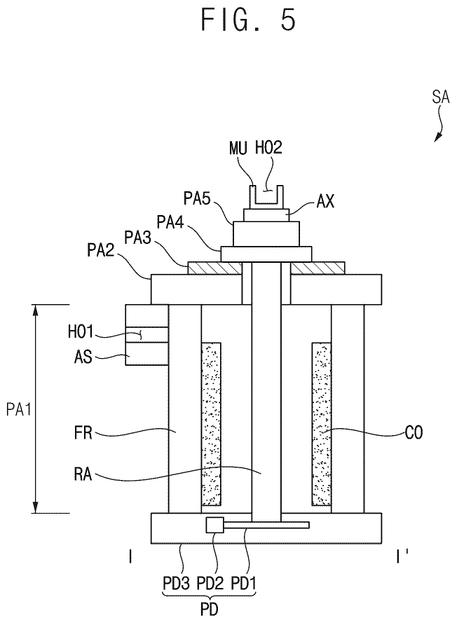

The mirror fixture SA may fix the Galvo mirror MR. In an embodiment, the mirror fixture SA may include an encoder PD, a motor MD, and a mount MU. Detailed features of the mirror fixture SA will be described below with reference to FIGS. 4 and 5.

Referring to FIG. 1, in an embodiment, the lens unit 400 may be disposed under the scanner 300. In an embodiment, for example, the lens unit 400 may be connected to the scanner 300 by the lens adapter AD included in the housing FB of the scanner 300. However, the disclosure is not limited thereto.

The lens unit 400 may focus the laser beam L provided from the scanner 300. The laser beam L focused by the lens unit 400 may be radiated to the stage 100. Specifically, the laser beam L focused by the lens unit 400 may be radiated to the object to be processed SUB.

In an embodiment, the object to be processed SUB may be a substrate. In an embodiment, for example, the substrate may include a glass. However, the disclosure is not limited thereto. In another embodiment, for example, the substrate may include a silicon wafer, plastic, or the like.

The lens unit 400 may be an F-theta lens unit. In an embodiment, for example, the lens unit 400 may include a lens housing and at least one lens. However, the disclosure is not limited thereto.

The lens housing may have a barrel shape. The at least one lens may be accommodated inside the lens housing.

The at least one lens may include a material with high light transparency. In an embodiment, for example, the at least one lens may include zinc selenide (“ZnSe”), germanium (“Ge”), or the like. These may be used alone or in combination with each other. However, the disclosure is not limited thereto. In an embodiment, for example, the at least one lens may include various materials.

The lens unit 400 may form a focus at which the laser beam L is incident on the scan field. The lens unit 400 may transmit constant energy to the object to be processed SUB regardless of an radiation position of the laser beam L.

The aligner 500 may adjust a tilt of the scanner 300. Specifically, the scan field of the scanner 300 and an upper surface of the object to be processed SUB may be adjusted to be parallel.

The control unit 600 may control the stage 100, the laser source 200, the scanner 300, and the aligner 500.

In an embodiment, for example, the stage 100 may move up and down, left and right, or rotate in response to a control signal from the control unit 600. However, the disclosure is not limited thereto.

In an embodiment, for example, the laser source 200 may change wavelength, amplitude, energy density, or the like of the laser L in response to the control signal applied thereto from the control unit 600. However, the disclosure is not limited thereto.

In an embodiment, for example, the scanner 300 may be tilted about a first axis or about a second axis in response to the control signal from the control unit 600. The second axis may cross the first axis. In an embodiment, for example, the first axis may be the Y-axis, and the second axis may be the X-axis. However, the disclosure is not limited thereto.

In an embodiment, for example, the Galvo mirror MR (e.g., the first mirror and the second mirror) included in the scanner 300 may move the first axis in response to the control signal from the control unit 600. In an embodiment, for example, the first mirror may rotate around the first axis, and the second mirror may rotate about the second axis. However, the disclosure is not limited thereto.

In an embodiment, for example, the aligner 500 may tilt the scanner 300 in response to the control signal from the control unit 600. In an embodiment, for example, the aligner 500 may tilt the scanner 300 about the first axis and/or the second axis in response to the control signal from the control unit 600. As described above, the first axis and the second axis may be rotation axes of the Galvo mirror MR.

FIG. 4 is a side view illustrating the mirror fixture of FIG. 3. FIG. 5 is a cross-sectional view taken along line I-I′ of FIG. 4.

Referring to FIGS. 3, 4, and 5, in an embodiment, the mirror fixture SA may include the encoder PD, the motor MD, and the mount MU.

The encoder PD may obtain location information of the scanner 300 and output an encoder signal corresponding to the location information.

In an embodiment, for example, the encoder PD may include a first encoder and a second encoder. In an embodiment, for example, the first encoder may be included in the first assembly (the first assembly AS1 of FIG. 3), and the second encoder may be included in the second assembly (the second assembly AS2 of FIG. 3). For example, the first encoder may detect a position in the +X direction and output a first encoder signal corresponding to the position in the +X direction. The second encoder may detect a position in the +Y direction and output a second encoder signal corresponding to the position in the +Y direction.

Based on the first encoder signal and the second encoder signal, the control unit (e.g., the control unit 600 of FIG. 1) may generate the control signal for controlling the scanner 300. However, the disclosure is not limited thereto. In an embodiment, for example, in the scanner 300, the encoder PD may be omitted or more encoders PD may be included.

At least one antenna CA may be disposed on the encoder PD. In an embodiment, for example, the encoder PD may include a first antenna CA1 and a second antenna CA2. Each of the first antenna CA1 and the second antenna CA2 may be supplied with power. In addition, each of the first antenna CA1 and the second antenna CA2 may transmit and receive data. In an embodiment, for example, each of the first antenna CA1 and the second antenna CA2 may exchange a signal to and from the encoder disposed on the stage to synchronize the positions of the stage (e.g., the stage 100 of FIG. 1) and the scanner (e.g., the scanner 300 of FIG. 3). However, the disclosure is not limited to this.

In an embodiment, the motor MD may be positioned on the encoder PD. In an embodiment, the motor MD mat include a first part PA1, a second part PA2, a third part PA3, a fourth part PA4, and a fifth part PA5 sequentially positioned on the encoder PD. Hereinafter, for convenience of description, the encoder PD and the first part PA1 are also referred to as a seating part SB.

In an embodiment, the first part PA1 may include a coil CO and a frame FR surrounding the coil CO. The coil CO may be disposed inside the frame FR. The coil CO may provide rotational force to the Galvo mirror (e.g., the Galvo mirror MR of FIG. 3).

In an embodiment, the motor MD may further include an air supply unit AS. In an embodiment, the air supply unit AS may protrude outward from the first part PA1. In such an embodiment, the coil may be disposed inside the first part PA1, and air may be supplied to the coil from the air supply unit AS protruding outside the first part PA1. A first hole HO1, through which air may enter and exit, may be defined in the air supply unit AS. The air may effectively transfer heat generated in the coil for cooling.

In an embodiment, the air supply unit AS may have a square shape in a plan view. In an embodiment, for example, the air supply unit AS has a first side, a second side, a third side, and a fourth side. The second side and the third side may cross the first side. The fourth side may parallel to the first side and cross both the second side and the third side.

The second part PA2 may be disposed on the first part PA1. The second part PA2 may be a part assembled with the housing (e.g., the housing FB of FIG. 2).

In an embodiment, for example, the second part PA2 may have a flat plate shape. A second hole HO2 may be defined in the second part PA2 having the flat plate shape. In an embodiment, for example, the second hole HO2 may have a screw thread shape inside. Accordingly, the housing and the mirror fixture SA may be bolted. However, the disclosure is not limited thereto. The housing and the mirror fixture SA may be assembled in various ways.

In an embodiment, the third part PA3 may be positioned on the first part PA1. Specifically, the third part PA3 may be disposed on the second part PA2.

In an embodiment, the third part PA3 may have a cylindrical shape with a reference diameter that serves as an assembly standard (i.e., a diameter R3 of the third part PA3).

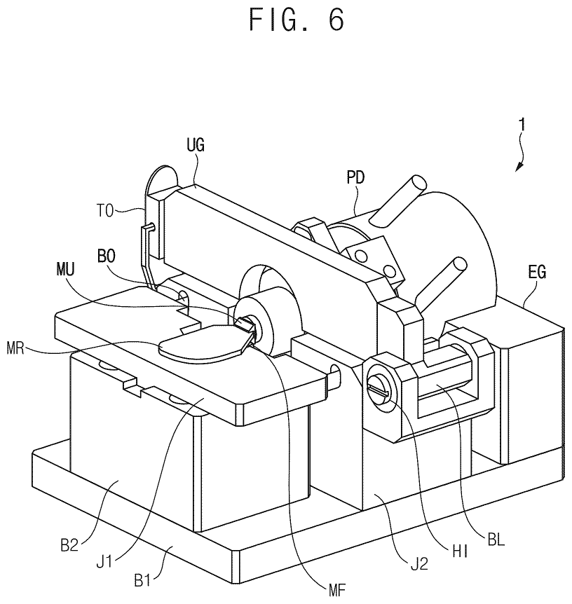

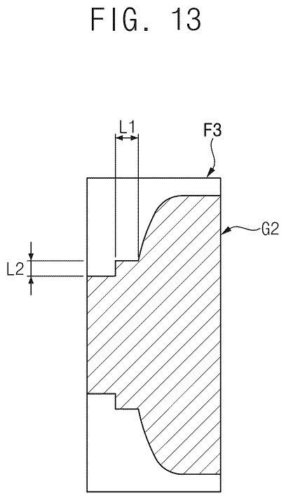

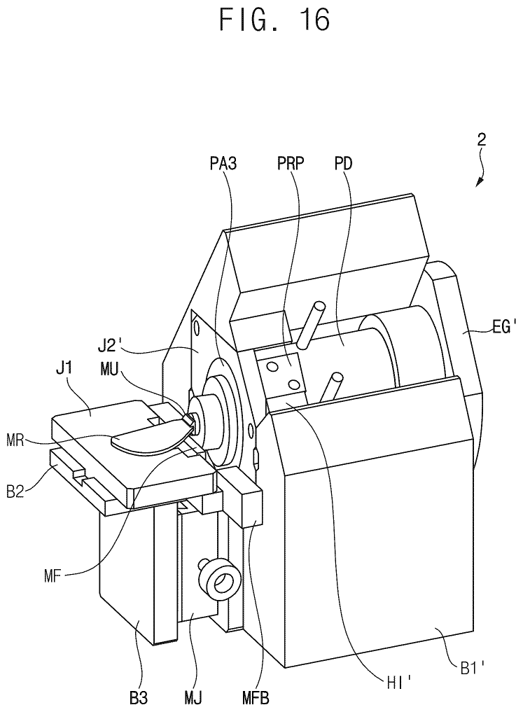

In an embodiment of the assembly device of the scan mirror (e.g., the assembly device of the scan mirror according to an embodiment of the disclosure of FIG. 6 or the assembly device of the scan mirror according to an embodiment of the disclosure of FIG. 16), the third part PA3 may be a reference point for fixing the mirror fixture SA (e.g., hereinafter, referred as “motor”). As shown in FIGS. 4 and 5, the third part PA3 may have a cylindrical shape. Detailed features of the third part PA3 will be described below with reference to FIG. 13.

In an embodiment, the mount MU may be positioned on the third part PA3. In an embodiment, for example, the fourth part PA4 may be disposed on the third part PA3. The fifth part PA5 may be disposed on the fourth part PA4. The mount MU may be disposed on the fifth part PA5.

In an embodiment, the Galvo mirror MR may be coupled to the mount MU. In such an embodiment, a groove, into which the Galvo mirror MR fits, may be defined in the mount MU.

In an embodiment, the Galvo mirror MR may receive the rotational force of the coil CO. In an embodiment, for example, an axis AX (e.g., a rotation axis) may be connected to the mount MU. Accordingly, the mount MU may also rotate together with the axis AX. The Galvo mirror MR may be coupled to the mount MU. Accordingly, the Galvo mirror MR may also rotate together with the mount MU.

The laser processing device 1000 according to an embodiment of the disclosure described above with reference to FIGS. 1, 2, 3, 4, and 5 is merely an example, and the laser processing device 1000 may further include more various components, or some of the above components may be omitted. In addition, the above components may be changed in various ways.

As the laser processing device 1000 repeats the processing process (e.g., the cutting process), damage may accumulate on the Galvo mirror MR. For example, as the laser processing process is repeated, a defect may occur in which a coating film on a surface of the Galvo mirror MR is peeled off.

The coating film of the Galvo mirror MR may reflect about 99% of the laser beam L. However, as the coating film is peeled off, the reflection efficiency of the Galvo mirror MR may decrease.

A cost of replacing the entire scanner 300 may be greater than a cost of replacing only the Galvo mirror MR from which the coating film has been peeled. Therefore, replacing the damaged (e.g., the coating film is peeled off) Galvo mirror may be more economical than replacing the entire scanner 300.

Hereinafter, the assembly device of the scan mirror that may replace only the Galvo mirror MR in which the defect occurred in the scanner 300 (e.g., the assembly device of the scan mirror 1 according to the embodiment of FIG. 6 or the assembly device of the scan mirror 2 according to the embodiment of FIG. 16) will be described.

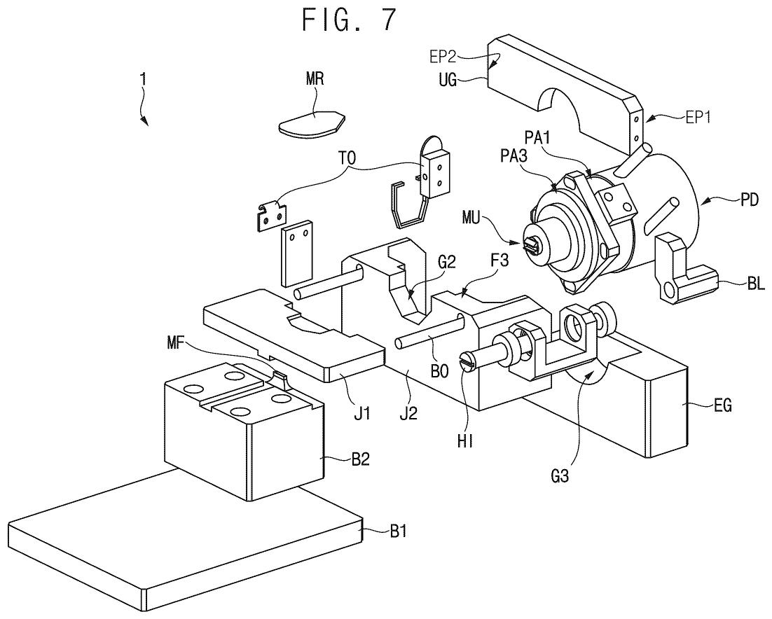

FIG. 6 is a perspective view illustrating the assembly device of the scan mirror according to an embodiment. FIG. 7 is an exploded perspective view of the assembly device of the scan mirror of FIG. 6.

Hereinafter, any repetitive detailed descriptions of the same or like elements as those of the scanner 300 described above with reference to FIGS. 1, 2, 3, 4, and 5 will be omitted or simplified.

Referring to FIGS. 6 and 7, the assembly device of the scan mirror 1 according to an embodiment may be a device for assembling the Galvo mirror MR to the mount MU.

In an embodiment, as described above, the scan mirror may include the encoder PD, the first part PA1 positioned on the encoder and include the coil, the third part PA3 positioned on the first part PA1 and has the reference diameter that serves as the assembly standard, the mount positioned on the third part PA3, and the Galvo mirror coupled to the mount MU to receive the rotational force of the coil.

In an embodiment, as shown in FIG. 6, the assembly device of the scan mirror 1 may include a first base B1, a second base B2, an encoder base EG, a first assembly jig J1, and a second assembly jig J2, a mount fixture MF, an upper fixing guide UG, and a hinge TO.

In an embodiment, the first base B1 may be positioned under the first assembly jig J1 and the second assembly jig J2, and the first assembly jig J1 and the second assembly jig J2 may be fixed. In such an embodiment, the first base B1 may be positioned under the encoder base EG and may fix the encoder base EG.

In an embodiment, for example, a plurality of protrusions may be defined or formed on the first base B1, and a plurality of protrusion grooves may be defined or formed on the first assembly jig J1, the second assembly jig J2, and the encoder base EG. Accordingly, the protrusion and the protrusion groove may be fitted into each other. However, the disclosure is not limited thereto. In an embodiment, for example, the first assembly jig J1, the second assembly jig J2, and the encoder base EG may be fixed to the first base B1 in various ways, e.g., by bolts.

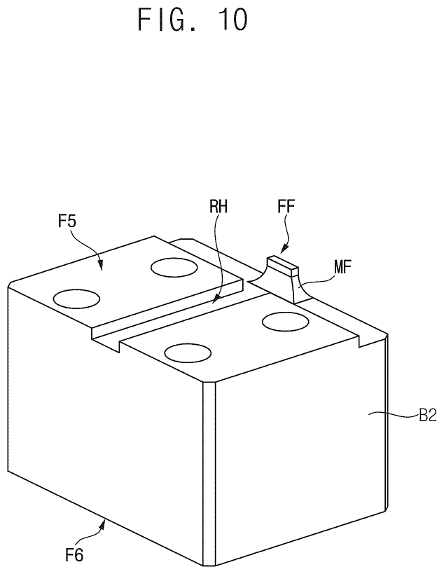

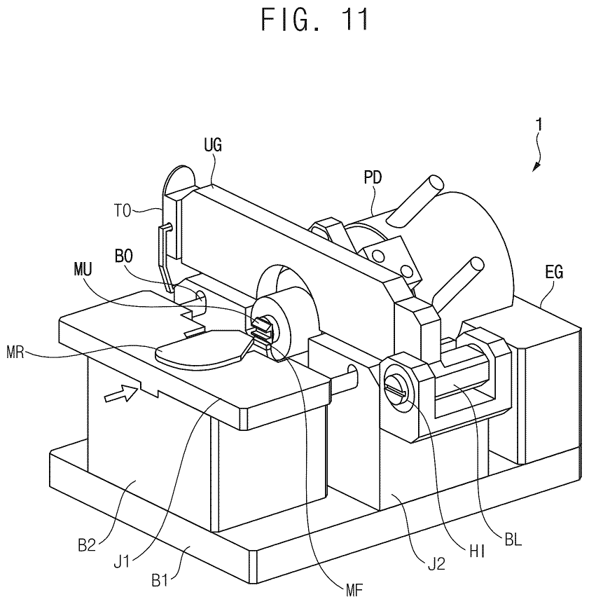

In an embodiment, the second base B2 may be disposed on the first base B1. Detailed features of the second base B2 will be described below with reference to FIG. 10.

In an embodiment, the encoder base EG may be positioned to be spaced apart from the second assembly jig J2. In an embodiment, a third groove G3, on which the encoder PD may be seated, may be defined in the encoder base EG.

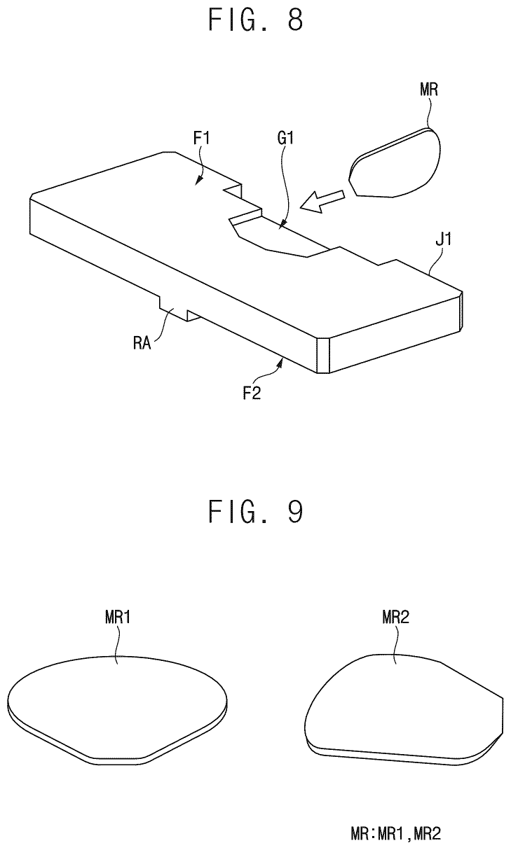

In an embodiment, the first assembly jig J1 may be disposed on the second base B2. In an embodiment, a groove (e.g., the first groove G1 of FIG. 8), into which the Galvo mirror MR may be seated, may be defined in the first assembly jig J1. Detailed features of the first assembly jig J1 will be described below with reference to FIGS. 8 and 9.

In an embodiment, the second assembly jig J2 may be disposed on the first base B1.

In an embodiment, the mount fixture MF may be disposed on the second base B2. The mount fixture MF may seat the mount MU and prevent rotation of the mount MU. Detailed features of the mount fixture MF will be described below with reference to FIG. 10.

In an embodiment, as shown in FIG. 7, the assembly device of the scan mirror 1 may include the upper fixing guide UG, a first hinge HI, and the hinge TO. Detailed features of the upper fixing guide UG, the first hinge HI, and the hinge TO will be described below with reference to FIGS. 13, 14, and 15.

FIG. 8 is a view illustrating the first assembly jig included in the assembly device of the scan mirror of FIG. 6. FIG. 9 is a view illustrating the Galvo mirror mounted on the first assembly jig of FIG. 8.

Referring to FIGS. 7 and 8, in an embodiment, the first assembly jig J1 may be disposed on the second base B2.

In an embodiment, the first assembly jig J1 may include a first surface F1 and a second surface F2. The first surface F1 and the second surface F2 may be opposite to each other in one direction or a thickness direction of the first assembly jig J1.

In an embodiment, the first groove G1 may be defined on the first surface F1. The Galvo mirror MR may be seated in the first groove G1.

In an embodiment, the shape of the first groove G1 of the first assembly jig J1 may correspond to the shape of the Galvo mirror MR. In other words, the first assembly jig J1 may be determined based on the shape of the Galvo mirror MR. In an embodiment, for example, when replacing the first mirror in the scanner (e.g., the scanner 300 of FIG. 1), the first assembly jig J1, in which the first groove corresponding to the shape of the first mirror is formed, may be used. In an embodiment, when replacing the second mirror in the scanner, the first assembly jig J1, in which the first groove corresponding to the shape of the second mirror, is formed may be used.

FIG. 10 is a view illustrating the second base included in the assembly device of the scan mirror of FIG. 6.

Referring to FIG. 10, in an embodiment, the mount fixture MF may include a flat surface FF. The mount MU may be seated on the flat surface FF of the mount fixture MF, thereby effectively preventing rotation of the mount MU.

FIGS. 11, 12, 13, 14, and 15 are views illustrating an embodiment of a method of assembling the scan mirror using the assembly device of the scan mirror of FIG. 6.

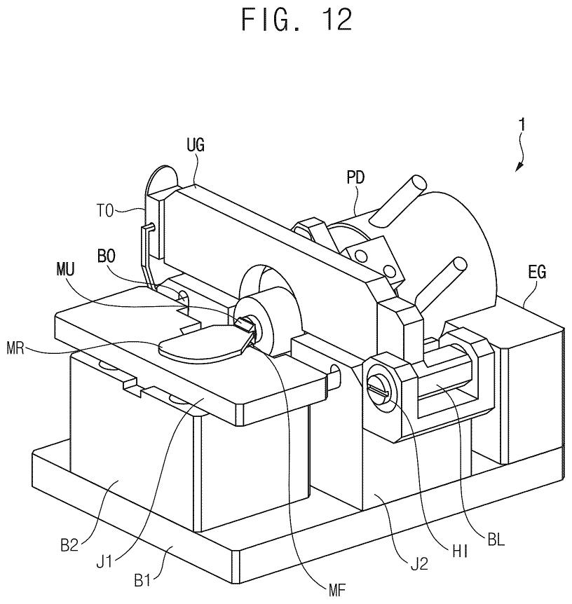

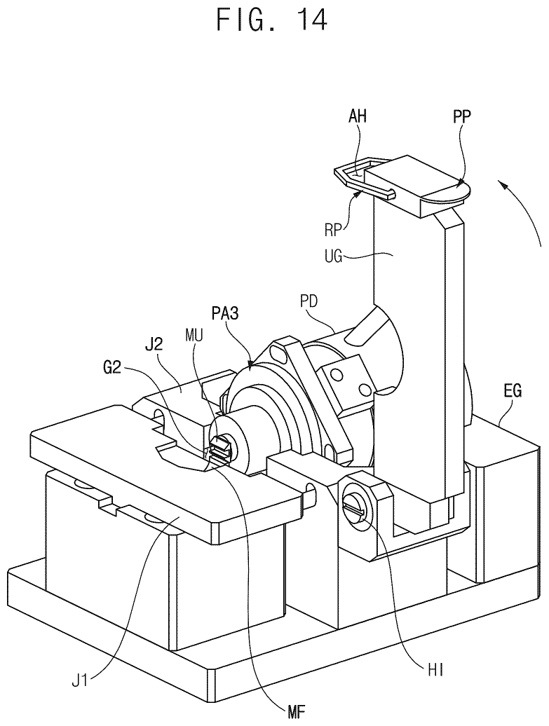

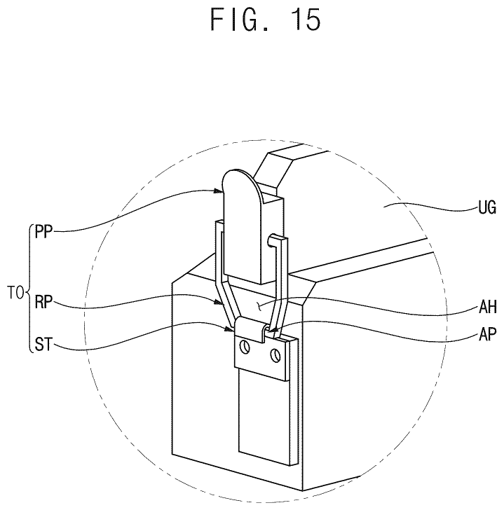

Particularly, FIGS. 11 and 12 are views illustrating attachment and detachment of the first assembly jig. FIGS. 13 and 14 are views illustrating the assembly reference point of the assembly device of the scan mirror. FIG. 15 is a view illustrating the one-touch hinge.

Referring to FIGS. 11 and 12, in an embodiment, the first assembly jig J1 may be detachably coupled to the second base B2.

In an embodiment, the first assembly jig J1 may include a rail RA on the second surface F2. The rail RA of the first assembly jig J1 may be fitted into a rail groove RH of the second base B2. The rail RA may move linearly along the rail groove RH. Accordingly, the first assembly jig J1 may move to be adjacent to or spaced apart from the mount fixture MF.

In an embodiment, the Galvo mirror MR may be seated on the first assembly jig J1. Next, the first assembly jig J1 may be seated on the second base B2. Next, the first assembly jig J1 may be linearly moved toward the mount fixture MF. Finally, the Galvo mirror MR on the first assembly jig J1 may be fitted and coupled to the mount MU on the mount fixture MF.

As described above, in the scanner (e.g., the scanner 300 of FIG. 1), damage (e.g., peeling of the coating film) to the Galvo mirror MR may occur due to the laser beam. For example, the cost of replacing the scanner may be substantially high, e.g., approximately 0.4 billion Korean won. However, when using the assembly device of the scan mirror 1 according to an embodiment, only the damaged Galvo mirror MR in the scanner may be redisposed, thereby reducing facility maintenance costs. For example, the replacement cost of the Galvo mirror MR may be substantially reduced to be approximately 0.05 billion Korean won.

In such an embodiment, the mount fixture MF may include the flat surface FF to effectively prevent rotation of the mount MU by the motor (e.g., the motor MD of FIG. 3). Accordingly, the Galvo mirror MR may be quickly and accurately assembled to the mount MU.

In such an embodiment, the Galvo mirror MR on the first assembly jig J1 may be assembled to the mount MU on the mount fixture MF along the rail RA. Accordingly, straightness may be secured without additional devices.

In such an embodiment, the first assembly jig J1 may be detachably coupled to the second base B2 and may correspond to various shapes and sizes of the Galvo mirror MR. In addition, the first assembly jig J1 may be easily assembled and/or disassembled from the second base B2.

Referring to FIGS. 4, 7, 13, and 14, in an embodiment, a second groove G2 may be defined on the third surface F3 of the second assembly jig J2. In an embodiment, the motor may be fixed based on the third part PA3. In such an embodiment, the second groove G2 may be formed based on the shape of the third part PA3.

In an embodiment, for example, in the second groove G2, the second assembly jig J2 may contact the third part PA3 by a first length L1 and a second length L2.

In an embodiment, for example, the third part PA3 may be positioned between the second part PA2 and the fourth part PA4. The third part PA3 may have a height that protrudes from the second part PA2 by the first length L1.

In an embodiment, for example, the third part PA3 may have the diameter R3 of a predetermined size. In an embodiment, for example, the fourth part PA4 may be a part surrounding the rotation axis (e.g., the axis AX of FIG. 4). In such an embodiment, the diameter of the fourth part PA4 may be sufficient to surround the rotation axis. Accordingly, the diameter of the fourth part PA4 may be smaller than the diameter R3 of the third part PA3. In an embodiment, the first part PA1 may be the part surrounding the coil (e.g., the coil CO of FIG. 5). In such an embodiment, the diameter of the first part PA1 may be larger than the diameter R3 of the third part PA3.

In an embodiment, for example, the second length L2 may mean half of the length excluding the diameter of the fourth part from the diameter R3 of the third part PA3.

In such an embodiment, remaining parts excluding the part in contact with the third part PA3, may have large tolerances. The assembly device of the scan mirror 1 according to an embodiment may fixe the motor (e.g., the third part PA3) by the upper fixing guide UG and the hinge TO, which will be described later. Accordingly, the size of the third groove G3 in which the encoder PD is seated, the size of the groove formed in the upper fixing guide UG, or the like may be changed in various ways.

Referring to FIGS. 6, 7, 14, and 15, in an embodiment, the assembly device of the scan mirror 1 according to an embodiment may include the upper fixing guide UG, the first hinge HI, and the hinge TO.

In an embodiment, the upper fixing guide UG may be positioned on the second assembly jig J2. The upper fixing guide UG may fix the motor (e.g., the third part PA3) together with the second assembly jig J2.

In an embodiment, the first hinge HI may connect the second assembly jig J2 and the upper fixing guide UG. The upper fixing guide UG may rotate based on the hinge axis of the first hinge HI.

In an embodiment, the hinge TO may include a pressing plate PP, a rotating plate RP, and a stopper ST.

In an embodiment, the pressing plate PP may be disposed at a second end EP2 opposite a first end EP1 of the upper fixing guide UG. In an embodiment, the first end EP1 may rotate around the hinge axis of the first hinge HI. Accordingly, the upper fixing guide UG may be opened and closed based on the first hinge HI. In other words, the first end EP1 may mean a part where the upper fixing guide UG opens and closes.

In an embodiment, the rotating plate RP may be rotatably connected to the pressing plate PP. A fastening hole AH may be defined in the rotating plate RP.

In an embodiment, the stopper ST may be disposed in the second assembly jig J2. The stopper ST may include an engaging protrusion AP coupled to the fastening hole AH of the rotating plate RP.

In an embodiment, as shown in FIG. 14, the motor (e.g., the third part PA3) may be operated in a state in which the upper fixing guide UG and the hinge TO are decoupled. In such an embodiment, the motor may be seated in the second groove G2 in the state.

In an embodiment, as shown in FIG. 11, the motor (e.g., the third part PA3) may be connected to the upper fixing guide UG and the hinge TO. In such an embodiment, the motor may be fixed by the fixing guide UG and the second assembly jig J2.

By rotating the upper fixing guide UG, the upper fixing guide UG may be lifted. In an embodiment, the upper fixing guide UG may be seated on the second assembly jig J2 based on the third part PA3. At this time, the encoder PD may be supported by the encoder base EG. At this time, the mount MU may be seated on the mount fixture MF. Next, the upper fixing guide UG may be rotated to close the upper fixing guide UG. In an embodiment, the upper fixing guide UG may be fixed using the hinge TO. That is, by fastening the hinge TO, movement (e.g., rotation) of the upper fixing guide UG may be effectively prevented.

In an embodiment, as described above, the third part PA3 may be the reference point for fixing the assembly device of the scan mirror (e.g., the assembly device of the scan mirror 1 of FIG. 6). In an embodiment, the third part PA3 may have a cylindrical shape. Accordingly, the motor (e.g., the motor MD of FIG. 3) may be fixed regardless of an angle, and the Galvo mirror MR may be easily assembled to the motor.

In a case of an assembly device of a scan mirror according to a comparative embodiment, a protruding part (e.g., an air supply unit AS protruding from the first part PA1), or the like may be taken into consideration when fixing an outer surface of the motor. In this case, time spent for seating may increase to avoid the protruding part or to fit and secure the protruding part.

However, in a case of the assembly device of the scan mirror according to an embodiment of the disclosure (e.g., the assembly device of the scan mirror 1 of FIG. 6), the motor may be fixed based on the third part PA3. Accordingly, the motor may be fixed regardless of the angle without considering the protruding part. Accordingly, the motor may be fixed more quickly and accurately than the assembly device of the scan mirror according to the comparative embodiment.

In such an embodiment, the assembly device of the scan mirror may include a structure in which the upper fixing guide UG opens and closes based on the first hinge HI. Accordingly, other fixing parts such as bolts might not be included, thereby reducing equipment manufacturing costs.

In such an embodiment, the assembly device of the scan mirror may be coupled with one touch using the hinge TO, allowing the motor to be easily fixed and/or released.

The assembly device of the scan mirror 1 according to the embodiments described above with reference to FIGS. 6,7, 8, 9, 10, 11, 12, 13, 14, and 15 is merely an example, and the components included in the assembly device of the scan mirror 1 may be changed variously.

In an embodiment, for example, the first assembly jig J1 and the second assembly jig J2 may be coupled by a rod BO protruding from the second assembly jig J2. In such an embodiment, a rod hole into which the rod BO may be inserted may be defined or formed in the first assembly jig J1. However, the disclosure is not limited thereto. The first assembly jig J1 and the second assembly jig J2 may be combined in various ways.

In an embodiment, the assembly device of the scan mirror 1 may further include a fastening block BL. In an embodiment, for example, the fastening block BL may have an ‘L’ shape. In an embodiment, for example, the L-shape may include a vertical portion and a horizontal portion that crosses the vertical portion. A through hole may be defined or formed in the horizontal portion. The first hinge HI may be disposed in (or inserted into) the through hole. The vertical portion may be bolted to the upper fixing guide UG. However, the disclosure is not limited thereto. The fastening block BL may have various shapes. Alternatively, the fastening block BL may be omitted.

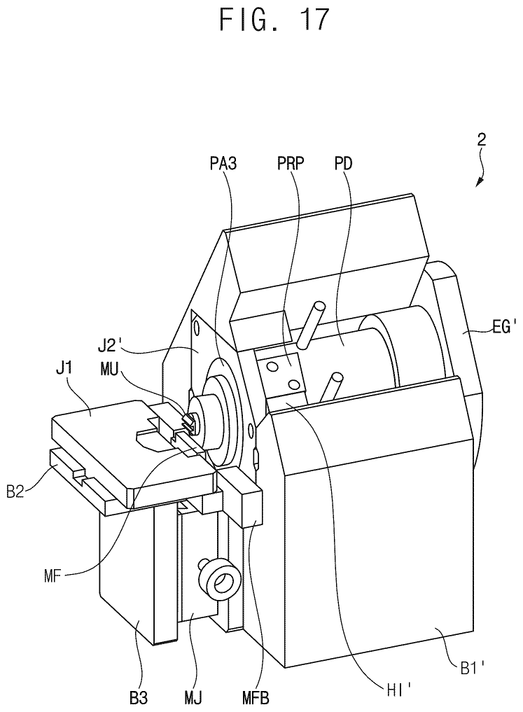

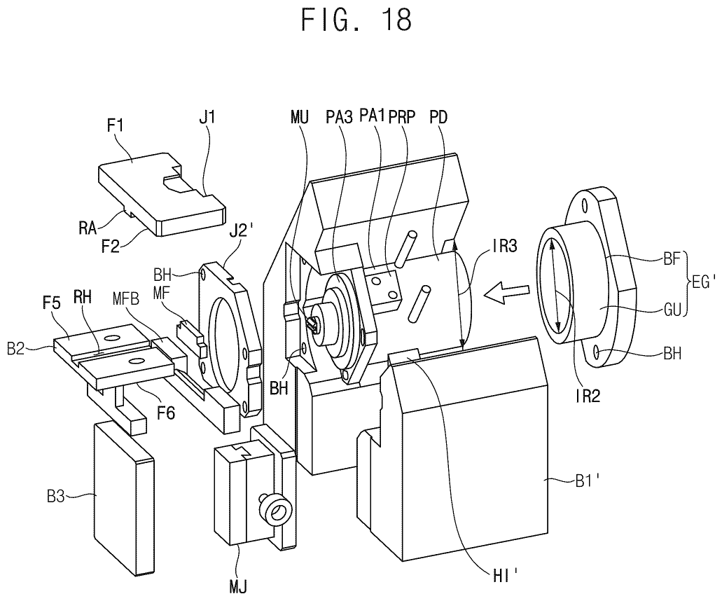

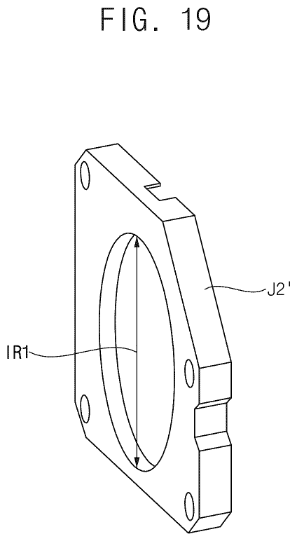

FIGS. 16 and 17 are perspective views illustrating the assembly device of the scan mirror according to another embodiment. FIG. 18 is an exploded perspective view of the assembly device of the scan mirror of FIG. 16. FIG. 19 is a view illustrating a second assembly jig included in the assembly device of the scan mirror of FIG. 16.

Hereinafter, any repetitive detailed descriptions of the same or like elements as those of the scanner 300 described above with reference to FIGS. 1, 2, 3, 4, and 5 and those of the assembly device of the scan mirror 1 described with reference to FIGS. 6, 7, 8, 9, 10, 11, 12, 13, 14, and 15 will be omitted or simplified.

Referring to FIGS. 4, 16, 17, 18, and 19, the assembly device of the scan mirror 2 according to an embodiment is a device for assembling the Galvo mirror MR to the mount MU.

In an embodiment, as described above, the scan mirror may include the encoder PD, the first part PA1 positioned on the encoder PD and including the coil (e.g., the coil CO of FIG. 5), the third part PA3 positioned on the first part PA1 and having the reference diameter that serves as the assembly standard, the mount MU positioned on the third part PA3, the mount MU, and the Galvo mirror MR that is coupled to the mount MU and receives the rotational force of the coil.

In an embodiment, as shown in FIG. 16, the assembly device of the scan mirror 2 may include a first base B1′, the second base B2, the third base B3, the first assembly jig J1, a second assembly jig J2′, a motor support bracket EG′, the mount fixture MF, and a manual jig MJ.

The first base B1′ may have various shapes to fix the motor (e.g., the motor MD of FIG. 3).

In an embodiment, for example, the first base B1′ may include a first part and a second part. The first part and the second part may fix the motor when being adjacent to each other, or release the motor when being separated from each other.

In an embodiment, for example, the first base B1′ may have a structure with an open top. Accordingly, there may be no interference with the antenna (e.g., the antenna CA of FIG. 4).

In an embodiment, the first part PA1 may be inserted and fixed into the first base B1′. In such an embodiment, a hollow groove may be formed in the first base B1′. The hollow groove may have a third inner diameter IR3. In an embodiment, for example, when the first part and the second part move to be adjacent to each other, the hollow groove may be formed inside the first part and the second part. The diameter of the hollow groove may be the third inner diameter IR3.

In an embodiment, the first base B1′ may further include a second hinge HI′. In an embodiment, for example, the motor may include a protrusion PRP. In an embodiment, for example, the protrusion PRP may be the air supply part (e.g., the air supply part AS of FIG. 4). The second hinge HI′ of the first base B1′ may effectively prevent movement of the motor by fixing the protrusion PRP.

In an embodiment, the air supply unit may have a square shape in the plan view. In such an embodiment, the second hinge HI′ may have a shape that may fix the air supply unit by contacting two opposing sides of the square shape. In an embodiment, the second hinge HI′ may protrude into the first base B1′.

In an embodiment, the second base B2 may be positioned under the first assembly jig J1 and may fix the first assembly jig J1. In an embodiment, the second base B2 may include the fifth surface F5 and the sixth surface F6. The fifth surface F5 and the sixth surface F6 may be opposite to each other in the one direction. The rail groove RH may be defined on the fifth surface F5. The sixth surface F6 may be in contact with the third base B3.

In an embodiment, the third base B3 may be positioned under the second base B2 and may fix the second base B2.

In an embodiment, the first assembly jig J1 may be spaced apart from the first base B1′ and positioned on the second base B2. In an embodiment, the first assembly jig J1 may include the first surface F1 and the second surface F2. The first surface F1 and the second surface F2 may be opposite to each other in the one direction. The first groove (e.g., the first groove G1 of FIG. 8) may be defined on the first surface F1. The Galvo mirror MR may be seated in the first groove.

In an embodiment, the shape of the first groove of the first assembly jig J1 may correspond to the shape of the Galvo mirror MR. In such an embodiment, the first assembly jig J1 may be determined based on the shape of the Galvo mirror MR. In an embodiment, when replacing the first mirror in the scanner (e.g., the scanner 300 of FIG. 1), the first assembly jig in which the first groove corresponding to the shape of the first mirror is formed J1 may be used. In an embodiment, when replacing the second mirror in the scanner, the first assembly jig J1 in which the first groove corresponding to the shape of the second mirror is formed may be used.

In an embodiment, the second assembly jig J2′ may have a first inner diameter IR1 into which the outer diameter R3 of the third part PA3 may be inserted and fixed. In such an embodiment, the assembly device of the scan mirror 2 according to an embodiment may quickly and accurately fix the motor by fixing the motor based on the third part PA3.

In an embodiment, the motor support bracket EG′ may include a contact surface BF and a guide GU. The contact surface BF may contact a bottom surface of the encoder PD. The guide GU may protrude from the contact surface BF to have a certain length and may have a second inner diameter IR2. Accordingly, the outer diameter R4 of the encoder PD may be inserted and fixed into the guide GU.

As described above with reference to FIG. 10, in an embodiment, the mount fixture MF may include the flat surface (e.g., the flat surface FF of FIG. 10). The mount MU may be seated on the flat surface FF of the mount fixture MF, thereby effectively preventing rotation of the mount MU.

In an embodiment, the second assembly jig J2′ and the first base B1′ may be coupled to each other, the motor support bracket EG′ and the first base B1′ may be coupled to each other. In an embodiment, the second assembly jig J2′ and the first base B1′ may be bolted, and the motor support bracket EG′ and the first base B1′ may also be bolted. Accordingly, the motor may be fixed more stably. In an embodiment, bolt holes BH may be defined or formed in the second assembly jig J2′, the first base B1′, and the motor support bracket EG′. However, the disclosure is not limited thereto. In an embodiment, for example, the fixing method of the second assembly jig J2′ and the first base B1′ and the fixing method of the motor support bracket EG′ and the first base B1′ may vary.

As described above with reference to FIGS. 11 and 12, in an embodiment, the first assembly jig J1 may be detachably coupled to the second base B2. In an embodiment, the first assembly jig J1 may include the rail RA on the second surface F2. The rail RA of the first assembly jig J1 may be fitted into the rail groove RH of the second base B2. The rail may move linearly along the rail groove RH. Accordingly, the first assembly jig J1 may move to be adjacent to or spaced apart from the mount fixture MF.

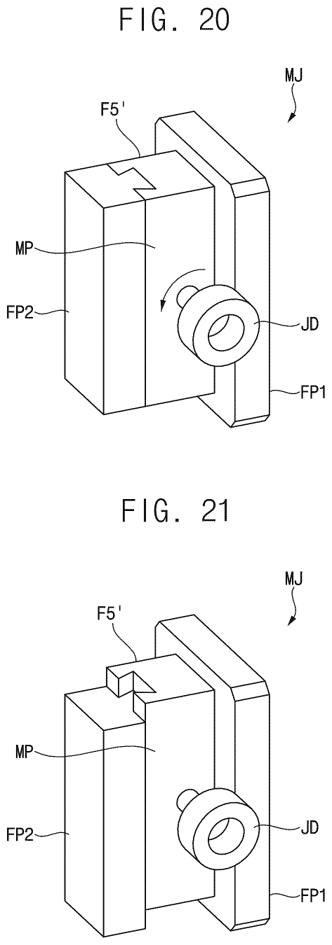

FIGS. 20 and 21 are views illustrating the manual jig included in the assembly device of the scan mirror of FIG. 16.

Referring to FIGS. 16, 17, 18, 20, and 21, in an embodiment, the assembly device of the scan mirror 2 may include the manual jig MJ. The manual jig MJ may be positioned between the first assembly jig J1 and the first base B1′.

In an embodiment, for example, the manual jig MJ may adjust the height of the upper surface F5′ based on the rotation of a jog dial. In an embodiment, the mount fixture MF may be positioned on the manual jig MJ. Accordingly, the height of the mount fixture MF may be adjusted by the manual jig MJ. Accordingly, it is possible to correspond to the Galvo mirror MR of various thicknesses.

The assembly device of the scan mirror 2 according to an embodiment described above with reference to FIGS. 16, 17, 18, 19, 20, and 21 is merely an example, and the components included in the assembly device of the scan mirror 2 may be changed in various ways.

In an embodiment, for example, a mount support block MFB may be further included between the mount fixture MF and the manual jig MJ. In an embodiment, for example, the mount support block MFB may be bolted to the first base B1′. Accordingly, movement of the mount fixture MF may be effectively prevented. However, the disclosure is not limited thereto.

As described above, the assembly device of the scan mirror 2 according an embodiment may include the manual jig MJ. Accordingly, the assembly device of the scan mirror 2 may effectively used for Galvo mirrors MR of various thicknesses.

The assembly device of a scan mirror according to embodiments may be applied to a scan mirror of a laser processing device used in various laser process.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. An assembly device of a scan mirror, wherein the scan mirror comprises: an encoder, a first part disposed on the encoder and including a coil, a third part disposed on the first part and of a cylindrical shape having a reference diameter which serves as an assembly standard, a mount disposed on the third part, and a Galvo mirror coupled to the mount to receive a rotational force of the coil, the assembly device comprising:
a first assembly jig including a first surface, wherein a first groove, into which the Galvo mirror is allowed to be seated, is defined on the first surface;
a second assembly jig including a third surface, wherein a second groove, into which the third part is allowed to be seated, is defined on the third surface; and
an upper fixing guide disposed on the second assembly jig, wherein the upper fixing guide fixes the third part together with the second assembly jig.

2. The assembly device of the scan mirror of claim 1, further comprising:
a first base disposed under the first assembly jig and the second assembly jig, wherein the first base fixes the first assembly jig and the second assembly jig; and
a second base including a fifth surface and a sixth surface, wherein the fifth surface is in contact with the first assembly jig, and the sixth surface is in contact with the first base.

3. The assembly device of the scan mirror of claim 2, wherein the first assembly jig is detachably coupled to the second base.

4. The assembly device of the scan mirror of claim 3, wherein,
a rail groove is defined on the fifth surface of the second base,
the first assembly jig further includes a rail,
wherein the rail is disposed on a second surface opposite the first surface, and
wherein the rail is fitted into the rail groove and movable linearly along the rail groove.

5. The assembly device of the scan mirror of claim 2, further comprising:
a mount fixture disposed on the second base,
wherein the mount fixture includes a flat surface, on which the mount is seated, wherein the mount fixture fixes the mount not to allow a rotation of the mount.

6. The assembly device of the scan mirror of claim 2, wherein
a shape of the first groove of the first assembly jig corresponds to a shape of the Galvo mirror.

7. The assembly device of the scan mirror of claim 1, further comprising:
a first hinge connecting the second assembly jig and the upper fixing guide and including a hinge axis,
wherein a first end of the upper fixing guide rotates around the hinge axis.

8. The assembly device of the scan mirror of claim 7, further comprising:
a hinge, the hinge comprising:
a pressing plate disposed at a second end opposite to the first end of the upper fixing guide;
a rotating plate rotatably connected to the pressing plate, wherein a fastening hole is defined through the rotating plate; and
a stopper disposed on the second assembly jig and including a coupling protrusion to which the fastening hole is coupled.

9. The assembly device of the scan mirror of claim 8, wherein,
the upper fixing guide is coupled to or decoupled from the second assembly jig by the hinge in a one-touch manner,
the third part is seated in the second groove in a state in which the upper fixing guide and the hinge are decoupled, and
the third part is fixed by the upper fixing guide and the second assembly jig in a state in which the upper fixing guide and the hinge are coupled.

10. The assembly device of the scan mirror of claim 8, further comprising:
an encoder base positioned to be spaced apart from the second assembly jig, wherein a third groove, in which the encoder is allowed to be seated, is defined on the encoder.

11. An assembly device of a scan mirror, wherein the scan mirror comprises: an encoder, a first part disposed on the encoder and including a coil, a third part disposed on the first part and of a cylindrical shape having a reference diameter which serves as an assembly standard, a mount disposed on the third part, and a Galvo mirror coupled to the mount to receive rotational force of the coil, the assembly device comprising:
a second assembly jig having a first inner diameter into which an outer diameter of the third part is allowed be inserted and fixed;
a motor support bracket including a contact surface in contact with a bottom surface of the encoder, and a guide that protrudes from the contact surface to have a certain length and has a second inner diameter into which the outer diameter of the encoder maybe inserted and fixed; and
a first base having a third inner diameter into which the first part is allowed be inserted and fixed,
wherein the second assembly jig and the first base are coupled to each other, and the motor support bracket and the first base are coupled to each other to fix the encoder, the first part, and the third part.

12. The assembly device of the scan mirror of claim 11, further comprising:
a first assembly jig spaced apart from the first base and including a first surface, wherein a first groove, into which the Galvo mirror is allowed be seated, is defined on the first surface;
a second base disposed under the first assembly jig and fixing the first assembly jig; and
a third base disposed under the second base and fixing the second base.

13. The assembly device of the scan mirror of claim 12, wherein the first assembly jig is detachably coupled to the second base.

14. The assembly device of the scan mirror of claim 13, wherein,
the second base includes a fifth surface and a sixth surface,
wherein a rail groove is defined on the fifth surface,
wherein the sixth surface contacts the third base,
the first assembly jig includes a rail,
wherein the rail is disposed on a second surface opposite the first surface, and
wherein the rail is fitted into the rail groove and movable linearly along the rail groove.

15. The assembly device of the scan mirror of claim 12, wherein a shape of the first groove of the first assembly jig corresponds to a shape of the Galvo mirror.

16. The assembly device of the scan mirror of claim 12, further comprising:
a manual jig positioned between the first assembly jig and the first base, wherein a height of an upper surface is adjusted by the manual jig.

17. The assembly device of the scan mirror of claim 16, further comprising:
a mount fixture disposed on the manual jig,
wherein the mount fixture includes a flat surface on which the mount is seated, wherein the mount fixture fixes the mount not to allow a rotation of the mount.

18. The assembly device of the scan mirror of claim 11, wherein,
the second assembly jig and the first base are coupled to each other with bolts,
the motor support bracket and the first base are to each other coupled with bolts.

19. The assembly device of the scan mirror of claim 11, further comprising:
an air supply part which protrudes from the first part, wherein an air hole is defined in the air supply part to supply air to an inside of the first part,
wherein the air supply part has a square shape in a plan view, and
wherein the first base protrudes inwardly to contact two opposite sides of the square shape and further includes a second hinge which fixes the air supply part.
